(19) United States
(12) Patent Application Publication
(10) Pub. No.: US 2009/0011254 A1
(43) Pub. Date: Jan. 8, 2009

(54) RELEASE FILM AND METHOD OF PRODUCING SAME

(75) Inventors: Kenji Yamamoto, Annaka-shi (JP); Tsutomu Nakajima, Takasaki-shi (JP); Masahiko Ogawa, Takasaki-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Shin-Etsu Chemical Co., Ltd., Chiyoda-ku (JP)

(21) Appl. No.: 12/167,458

(22) Filed: Jul. 3, 2008

(30) Foreign Application Priority Data
Jul. 5, 2007 (JP) 2007-177178

(51) Int. Cl. B32B 7/10; B05D 3/02

(52) U.S. Cl. 428/447; 427/224

(57) ABSTRACT

Provided is a release film, including a plastic film substrate, a surface modification layer formed on a single surface or both surfaces of the plastic film substrate by radiating a flame of a fuel gas including an organosilicon compound onto the single surface or both surfaces, and a silicone release layer composed of a cured product of a curable silicone composition, in which the silicone release layer is provided on top of the surface modification layer. The release film exhibits excellent adhesion between the silicone release layer and the plastic film substrate. The release film is produced at low cost and at a high level of productivity by a method including: forming the surface modification layer on a single surface or both surfaces of the plastic film substrate by radiating a flame of the fuel gas onto the single surface or both surfaces, and forming the silicone release layer on top of the surface modification layer by applying the curable silicone composition to the surface modification layer and then curing the composition.

### BACKGROUND OF THE INVENTION

1. Field of the Invention

The present invention relates to a release film that includes a silicone release layer formed on at least one surface of a plastic film substrate and exhibits excellent adhesion between the plastic film substrate and the silicone release layer, and also relates to a method of producing such a release film.

2. Description of the Prior Art

A process in which a release layer is provided on the surface of a substrate such as glassine paper, polyethylene-laminated paper or a plastic film, thereby imparting the substrate with release properties is widely used. A silicone composition is used as the material for forming this type of release layer. For example, silicone compositions composed of an alkenyl group-containing organopolysiloxane, an organohydrogenpolysiloxane, and a platinum-based compound are well known (see patent references 1 and 2). These silicone compositions exhibit excellent curability and also have a favorable pot life, and are therefore in widespread use. However, depending on the substrate, the degree of adhesion between the cured film of the composition and the substrate is not always entirely satisfactory, and this has created some problems, including a limited range of substrates that may be coated, or a requirement to subject the substrate to a pretreatment.

In recent years, the use of substrates formed from plastic films of uniform and stable quality, which exhibit a high degree of smoothness and are able to be formed as very thin films, has expanded considerably, and there are growing demands for improvements in the adhesion between these types of plastic films and cured silicone coatings. Furthermore, environmental concerns and a desire to improve the health and safety of the workplace environment have resulted in a trend towards aqueous silicone compositions, but in addition to the above problem of unsatisfactory adhesion, aqueous compositions also suffer from poor wetting properties of plastic film surfaces having a low surface tension, making it difficult to obtain a favorable coated surface.

Various improvements have been proposed for improving the adhesion and coating properties described above. Examples of these improvements include methods in which a material that exhibits favorable adhesion to plastics, such as a silane coupling agent or the like, is added to the silicone composition, methods in which the base polymer structure is imparted with a branched structure (see patent references 3 to 6), methods in which a solvent-based silicone composition is combined with a solventless silicone composition (see patent references 7 and 8), and the use of additives composed of a siloxane compound having a hydrocarbon group of a specific structure bonded thereto (see patent references 9 to 11).

However, as the potential uses of plastic films have expanded, the properties required of these plastic films have become increasingly advanced and diverse, and further improvements are still required.

Techniques in which the surface of the plastic film is altered, and thereby activated, are also used. Examples of these techniques include methods in which the film surface is subjected to a corona discharge treatment (see patent references 12 to 14), an ultraviolet irradiation treatment (see patent reference 15), a plasma and flame treatment (see patent reference 16), or a sandblasting treatment. However, none of these film surface activation techniques yields a particularly large effect, and the effect also tends to diminish over time.

Other known surface modification methods include etching methods in which the surface of the plastic film is either dissolved and swollen, or partially dissolved, using any of a variety of reagents. These methods involve bringing the film surface into contact with an acid, an alkali, an amine salt, trichloroacetic acid, or a phenol or the like, thereby etching the film surface, breaking down and dissolving the crystal orientation near the surface, and lowering the cohesiveness, with the aim of enhancing the adhesion of the film surface to a silicone release layer. However, the reagents used in these methods are often dangerous to handle, and considerable care must be taken to prevent environmental pollution or contamination of the working environment, meaning there are significant problems associated with practical application of these methods.

Methods that involve the provision of a primer layer between the silicone release layer and the plastic film have also been proposed, and these primer layers include layers that employ an aqueous resin (see patent reference 17), and layers that employ a specific silicon compound (see patent references 18 to 20). However, because these methods require twice as many coating steps, resulting in a reduction in productivity and an increase in costs, their industrial applicability is limited, and it has also been noted that the effects achieved tend to vary considerably depending on the coating and drying conditions employed.

Because methods that require formation of an inorganic film by vapor deposition or sputtering or the like involve conducting treatment in a vacuum, conducting treatments over large surface areas is problematic, and because the treatment time is also long, these modification methods are expensive. Moreover, the resulting adhesion between the modified film and the resin substrate is poor, and the modified film tends to be prone to peeling.

Methods in which coating films are formed from an inorganic oxide coating or a polymer coating or the like (see patent reference 21), and methods in which polymer graft chains are introduced at the surface of an activated plastic film (see patent reference 22) are also known. However, in methods that involve the formation of a coating film, the adhesion between the coating film and the plastic film is poor, and various problems arise, including peeling of the coating film under the usage conditions, or elution of the coating film if the product is used within a liquid. In the polymer grafting method, the step of activating the plastic film surface, which is necessary to perform the grafting, is quite complicated, and treatment of a large surface area is also problematic.

[Patent Reference 1] U.S. Pat. No. 3,770,639

[Patent Reference 2] EP 0 219 720 A2

[Patent Reference 3] JP 63-251465 A

[Patent Reference 4] U.S. Pat. No. 4,772,515

[Patent Reference 5] U.S. Pat. No. 5,942,591

[Patent Reference 6] EP 0 903 388 A2

[Patent Reference 7] JP 2000-169794 A

[Patent Reference 8] JP 2000-177058 A

[Patent Reference 9] U.S. Pat. No. 6,335,414

[Patent Reference 10] US 2004/0266925 A1

[Patent Reference 11] JP 2005-015666 A

[Patent Reference 12] JP 48-29316 B

[Patent Reference 13] U.S. Pat. No. 4,563,316

[Patent Reference 14] EP 0 761 726 A2

[Patent Reference 15] JP 5-68934 A

[Patent Reference 16] JP 9-124810 A

[Patent Reference 17] JP 6-340755 A

[Patent Reference 18] JP 7-3215 A

[Patent Reference 19] EP 0 682 068 A2

[Patent Reference 20] JP 2004-43625 A

[Patent Reference 21] JP 5-310979 A

[Patent Reference 22] JP 7-138394 A

### SUMMARY OF THE INVENTION

In this manner, a variety of methods have been proposed for improving the adhesion between silicone release layers and plastic film substrates, but no methods currently exist that satisfy the required level of performance while also offering superior productivity and minimal cost, and similarly, no release films are available that are able to adequately satisfy the high level of adhesion now being demanded.

Accordingly, the present invention provides a release film that exhibits excellent adhesion between the silicone release layer and the plastic film substrate, and also provides a method of producing such a release film at low cost and at a high level of productivity.

The inventors of the present invention discovered that by radiating the surface of a plastic film substrate with a flame of a fuel gas containing an organosilicon compound, such as one or more organosilanes selected from the group consisting of alkylsilanes and alkoxysilanes, a surface modification layer is formed that binds strongly to the surface of the plastic film substrate, and this layer is preferably a silica microparticle layer composed of nanosize silica microparticles. Moreover, they also discovered that by applying a curable silicone composition to this surface modification layer, and forming a silicone release layer composed of a cured product of the curable silicone composition on the surface of the plastic film substrate, a release film could be obtained at low cost and at a high level of productivity, and moreover, that this silicone release layer and the plastic film substrate exhibited excellent adhesion, and they were therefore able to complete the present invention.

In other words, a first aspect of the present invention provides a release film, comprising:

a plastic film substrate,

a surface modification layer formed on a single surface or both surfaces of the plastic film substrate by radiating a flame of a fuel gas comprising an organosilicon compound onto the single surface or both surfaces, and

a silicone release layer composed of a cured product of a curable silicone composition, wherein

the silicone release layer is provided on top of the surface modification layer.

A second aspect of the present invention provides a method of producing the above release film, the method comprising:

forming a surface modification layer on a single surface or both surfaces of the plastic film substrate by radiating a flame of a fuel gas comprising an organosilicon compound onto the single surface or both surfaces, and forming a silicone release layer composed of a cured product of a curable silicone composition on top of the surface modification layer, by applying the curable silicone composition to the surface modification layer and then curing the composition.

According to the present invention, a release film that exhibits excellent adhesion between the plastic film substrate and the silicone release layer, as well as excellent release properties can be produced at low cost, at a high level of productivity, and across a large surface area. Furthermore, by employing the present invention, not only are the coating properties onto releasable plastic film substrates of solventless silicone compositions and aqueous emulsion-based silicone compositions, which have conventionally proven difficult to use, improved considerably, enabling the production of release films with more diverse performance, but the production of release films without the use of solvents is simplified significantly, which is advantageous in terms of environmental friendliness and the health and safety of the workplace environment.

### DETAILED DESCRIPTION OF THE PREFERRED EMBODIMENTS

### Plastic Film Substrate

The plastic film substrate used in the present invention is a film or sheet composed of either one of, or both, a synthetic polymer compound and a natural polymer compound. Examples of the materials for the film or sheet include olefin resins such as polyethylene, polypropylene and cycloolefins; vinyl resins such as polyvinyl chloride, polystyrene, polyvinyl acetate and polyvinyl alcohol; acrylic resins such as polymethyl methacrylate; ester resins such as polyethylene terephthalate, polylactic acid and polyglycolic acid; fluororesins such as polytetrafluoroethylene and polyvinylidene fluoride; silicone resins such as polydimethylsiloxane; polycarbonate resins; polyimide resins; polyamide resins; and resins containing unsaturated bonds such as polybutadiene ad polyisoprene. These resins may be either homopolymers, or copolymers formed in combination with one or more other monomers. Furthermore, these resins may also include various additives such as colorants, diffusing agents, thickeners, and inorganic fine particles.

The plastic film substrate may be a laminated structure in which at least one layer such as a primer layer, an ink layer for decorative purposes or the like, or a protective hard coat layer or the like is formed in advance, either on a portion of, or across the entire surface of, the plastic film substrate.

There are no particular restrictions on the thickness of the plastic film substrate, but considering factors such as productivity and cost, a thickness of 0.5 to 100 μm is preferred.

### [Fuel Gas]

In the present invention, the fuel gas used for the radiated flame is a gas that comprises, as main constituents, a flammable gas such as a hydrocarbon gas like propane gas, or hydrogen gas, and an organosilicon compound, which is preferably at least one organosilane selected from the group consisting of alkylsilanes and alkoxysilanes. Both the flammable gas and the organosilicon compound may comprise either a single constituent or a combination of two or more different constituents.

The proportion of the flammable gas within the fuel gas is preferably not less than 80 mol % and not more than 99.9 mol %, and is even more preferably not less than 85 mol % and not more than 90 mol %. If this proportion is less than 80 mol %, then the mixing properties with the other constituent gases may deteriorate, leading to a deterioration in the combustion efficiency. If the proportion exceeds 99.9 mol %, then the effects of the flame treatment may sometimes deteriorate markedly.

### (Organosilicon Compound)

The organosilicon compound is preferably at least one organosilane selected from the group consisting of alkylsilanes and alkoxysilanes. Examples of the organosilane include compounds represented by the general formula shown below.

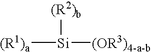

(wherein, R¹ represents an alkyl group of 1 to 8 carbon atoms that may include an ether linkage or ester linkage, wherein one hydrogen atom within the alkyl group is substituted with a moiety selected from the group consisting of halogen atoms, a vinyl group, epoxy group, acryloyloxy group, methacryloyloxy group, styryl group, amino group, N-substituted amino groups, mercapto group, perfluoroalkyl groups, ureido group, chloroalkyl groups, isocyanate group, acetoxy group and phenyl group, wherein examples of the substituents bonded to the nitrogen atom in the N-substituted amino groups include a β-aminoethyl group and a phenyl group,

R² and R³ each represent an alkyl group of 1 to 10 carbon atoms,

a represents an integer of 0 to 3, and b represents an integer of 0 to 4, provided that a+b is an integer from 0 to 4, and

when a represents either 2 or 3, the R¹ groups may be the same or different,

when b represents an integer from 2 to 4, the R² groups may be the same or different, and

when 4-a-b represents an integer from 2 to 4, the R³ groups may be the same or different)

Examples of R¹ in the above formula include a chloromethyl group, 2-chloroethyl group, 3-chloropropyl group, phenylmethyl group, 2-phenylethyl group, γ-acryloyloxypropyl group, γ-methacryloyloxypropyl group, γ-glycidoxypropyl group, 7-aminopropyl group, γ-mercaptopropyl group, N-β-(aminoethyl)-γ-aminopropyl group, and N-phenyl-γ-aminopropyl group.

Examples of the halogen atom include a fluorine atom, chlorine atom, bromine atom and iodine atom.

Examples of the perfluoroalkyl groups that may be used for substituting the one hydrogen atom within the alkyl group represented by R¹ include perfluoroalkyl groups of 1 to 8 carbon atoms, such as a perfluoromethyl group, perfluoroethyl group, perfluoropropyl group, perfluorobutyl group, perfluorohexyl group and perfluorooctyl group.

Examples of the chloroalkyl groups that may be used for substituting the one hydrogen atom within the alkyl group represented by R¹ include chloroalkyl groups of 1 to 8 carbon atoms, such as a chloromethyl group, 2-chloroethyl group, 1,1-dichloropropyl group and 3-chloropropyl group.

In the above formula, examples of the R² and R³ groups include a methyl group, ethyl group, propyl group, isopropyl group, butyl group, isobutyl group, sec-butyl group, tert-butyl group, pentyl group, isopentyl group, neopentyl group, hexyl group, heptyl group, 1-ethylpentyl group, octyl group, 2-ethylhexyl group, nonyl group and decyl group.

Specific examples of the organosilane include alkylsilanes such as tetramethylsilane, tetraethylsilane, bis(chloromethyl)dimethylsilane, tris(chloromethyl)methylsilane, bis(2-chloroethyl)diethylsilane, bis(phenylmethyl)dimethylsilane, bis(2-phenylethyl)diethylsilane and dimethyldiethylsilane; and alkoxysilanes such as methyltrimethoxysilane, dimethyldimethoxysilane and dimethyldiethoxysilane.

The proportion of the organosilicon compound within the fuel gas is preferably not less than 1×10⁻¹⁰ mol % and not more than 10 mol %, and is even more preferably not less than 1×10⁻⁹ mol % and not more than 5 mol %. If this proportion is less than 1×10⁻¹⁰ mol %, then the effects of the flame treatment may deteriorate markedly, whereas if the proportion exceeds 10 mol %, then the mixing properties of the organosilicon compound and air may deteriorate, causing incomplete combustion of the organosilicon compound.

Besides the flammable gas and the organosilicon compound, the fuel gas may also include an alkyltitanium compound, alkoxytitanium compound, alkylaluminum compound or alkoxyaluminum compound or the like. Examples of these compounds include tetramethyltitanium, trimethylaluminum, tetraethyltitanium, triethylaluminum, dimethyldiethyltetratitanium, methyldiethyltetraaluminum, methyldiethylaluminum, and dimethyldiethyltitanium. These compounds may be used either alone, or in combinations of two or more different compounds. By combining different compounds in this manner, excellent adhesion can be achieved to a wider range of plastic film substrates, and a surface modification layer can be obtained that yields favorable coating properties for all manner of different curable silicone compositions.

In order to improve the mixing properties of the fuel gas, a carrier gas such as air can be mixed into the fuel gas as the remaining portion.

### [Surface Modification Layer]

The surface modification layer is formed by radiating a fuel gas flame comprising an organosilicon compound onto a single surface or both surfaces of the plastic film substrate. There are no particular restrictions on the conditions for the flame radiation, provided the flame of the fuel gas contacts the plastic film substrate. The fuel gas flame can be generated, for example, by using a burner. The flame of the fuel gas should contact the plastic film substrate for approximately 0.1 to 100 seconds, preferably from 0.2 to 100 seconds, and most preferably from 0.3 to 60 seconds.

From the viewpoint of enhancing the adhesion between the plastic film substrate and the silicone release layer, the surface modification layer is preferably a silica microparticle layer composed of nanosize silica microparticles. Here, the expression “nanosize silica microparticles” refers to fine silica particles having an average particle size of not more than 1,000 nm (typically within a range from 1 to 1,000 nm), and preferably within a range from 1 to 500 nm. The average particle size can be determined from a transmission electron microscope image (TEM image) of the surface modification layer, by measuring the size of approximately 100 fine particles, and then averaging the measured values.

### [Curable Silicone Composition]

Various compositions may be used as the curable silicone composition used in the present invention, including commercially available compositions, and the composition may be solvent-based, solventless, emulsion-based, or an aqueous solution. The curing method is also not restricted in any particular manner, and condensation reaction curing, addition reaction curing, or photocuring (for example, photocationic polymerization reaction curing, or a photoradical polymerization reaction curing) may be used.

### (Condensation Reaction Curable Silicone Compositions)

A composition comprising the components described below may be used as a condensation reaction curable silicone composition. The components (A1), (B1) and (C1) may each be either a single compound, or a combination of two or more different compounds.

(A1): an organopolysiloxane having at least two hydroxyl groups within each molecule,

(B1): an organohydrogenpolysiloxane or organopolysiloxane having at least two, and preferably three or more, hydrogen atoms bonded to silicon atoms (hereafter referred to as SiH groups) or hydrolyzable groups within each molecule, and (C1): a catalyst.

### —Organopolysiloxane (A1)

Examples of the organopolysiloxane of the component (A1), having at least two hydroxyl groups within each molecule, include the compounds represented by a general formula (1) shown below.

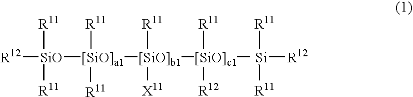

[wherein, each R¹¹ represents, independently, an alkyl group of 1 to 20 carbon atoms, a cycloalkyl group of 3 to 20 carbon atoms, or an aryl group of 6 to 20 carbon atoms, in which a portion of, or all of, the hydrogen atoms bonded to carbon atoms may be substituted with a halogen atom or a cyano group, R¹² represents a hydroxyl group, and X¹¹ represents a group represented by the formula shown below:

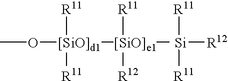

(wherein, R¹¹ and R¹² are as defined above), and
a1, b1, c1, d1 and e1 are positive numbers such that the viscosity at 25° C. of the organopolysiloxane (A1) is at least 0.05 Pa·s, the viscosity at 25° C. of a 30% toluene solution of the organopolysiloxane (A1) is within a range from 0.002 to 30 Pa·s, and preferably from 0.005 to 20 Pa·s, b1, c1, d1 and e1 may be zero, and a1, b1, c1, d1 and e1 preferably satisfy 28≦a1+b1×(d1+e1+2)+c1≦10,000].

In the above formulas, examples of the R¹¹ groups include alkyl groups such as a methyl group, ethyl group, propyl group, isopropyl group, butyl group, isobutyl group, sec-butyl group, tert-butyl group, pentyl group, isopentyl group, neopentyl group, hexyl group, heptyl group, 1-ethylpentyl group, octyl group, 2-ethylhexyl group, nonyl group, decyl group, dodecyl group, tetradecyl group, hexadecyl group, octadecyl group or eicosyl group; cycloalkyl groups such as a cyclopropyl group, cyclobutyl group, cyclopentyl group or cyclohexyl group; aryl groups such as a phenyl group, tolyl group, xylyl group or naphthyl group; and groups in which a portion of, or all of, the hydrogen atoms bonded to carbon atoms within the above hydrocarbon groups have been substituted with a halogen atom or a cyano group, such as a chloromethyl group, 2-bromoethyl group, 3,3,3-trifluoropropyl group, p-chlorophenyl group or 2-cyanoethyl group.

The hydroxyl groups of the organopolysiloxane (A1) undergo a condensation reaction with the SiH groups or hydrolyzable groups within the cross-linking agent (B1) described below, thereby curing the condensation reaction curable silicone composition. The organopolysiloxane (A1) must contain at least two hydroxyl groups within each molecule. If this number of hydroxyl groups is less than two, then the curing of the silicone composition becomes undesirably slow.

The hydroxyl group content per 100 g of the organopolysiloxane (A1) is preferably within a range from 0.0001 to 0.1 mols. If the hydroxyl group content is less than the lower limit of this range, then the curing of the silicone composition is slow, whereas if the hydroxyl group content exceeds the upper limit, the pot life of the composition tends to shorten. In the formula (1), the number of hydroxyl groups within a single molecule, represented by b1×(e1+1)+c1+2 is preferably within a range from 2 to 150.

### —Organopolysiloxane (B1)

The component (B1), which functions as a cross-linking agent in the condensation reaction with the component (A1), is an organohydrogenpolysiloxane or organopolysiloxane having at least two, and preferably three or more, hydrogen atoms bonded to silicon atoms or hydrolyzable groups within each molecule. The component (B1) is preferably used in a quantity such that the number of mols of SiH groups or hydrolyzable groups within the component (B1) is 5 to 200 times the number of mols of hydroxyl groups within the component (A1). Typically, the quantity of the component (B1) is within a range from 0.1 to 30 parts by mass per 100 parts by mass of the organopolysiloxane (A1). If the number of mols of SiH groups or hydrolyzable groups is less than the lower limit of this range, then the quantity of cross-linked bonding is insufficient, and the non-adhesiveness of a silicone release layer formed from a cured product of the silicone composition tends to deteriorate. On the other hand, no improvement in effects is observed even if the number of mols of SiH groups or hydrolyzable groups exceeds the above upper limit, and the cost performance ratio tends to deteriorate.

The organohydrogenpolysiloxane used as the component (B1) may be represented, for example, by the general composition formula shown below.

R⁴_{f}H_{g}SiO_{(4-f-g)/2}

(wherein, R⁴ has the same meaning as R¹¹ in the above general formula (1), f is a real number that satisfies 0≦f≦3, and g is a real number that satisfies 0≦g≦3, provided that f+g satisfies 1≦f+g≦3)

There are no particular restrictions on the organohydrogenpolysiloxane, provided it contains at least two, and preferably three or more, SiH groups within each molecule, and the molecular structure may be a straight-chain, branched-chain or cyclic structure. The viscosity of the organohydrogenpolysiloxane at 25° C. is typically within a range from several mPa·s to several tens of thousand mPa·s (for example, from 1 to 20,000 mPa·s, and preferably from 5 to 10,000 mPa·s).

Specific examples of the organohydrogenpolysiloxane used as the component (B1) include the compounds shown below.

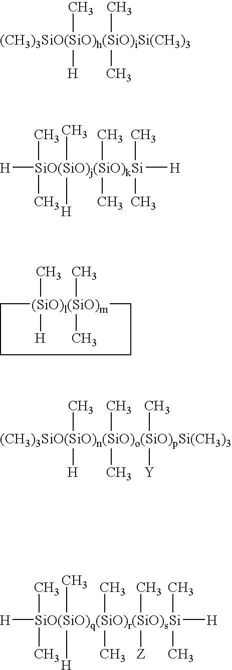

In the above structural formulas, Y and Z represent groups of the structural formulas shown below, and h through w represent integers within the following ranges. Namely, h, 1 and n each represent an integer from 3 to 500, m, p and s each represent an integer from 1 to 500, and i, j, k, o, q, r, t, u, v and w each represent an integer from 0 to 500.

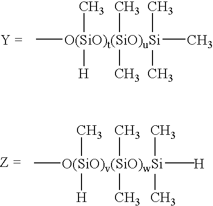

Examples of organopolysiloxanes containing hydrolyzable groups bonded to silicon atoms that may be used as the component (B1) include, for example, compounds of the general composition formula shown below.

R⁴_{f}W_{g}SiO_{(4-f-g)/2}

(wherein, W represents a hydrolyzable group, and R⁴, f and g are as defined above)

There are no particular restrictions on the organopolysiloxane of the component (B1), provided it contains at least two, and preferably three or more, hydrolyzable groups bonded to silicon atoms within each molecule, and the molecular structure may be a straight-chain, branched-chain or cyclic structure. The viscosity of the organopolysiloxane at 25° C. is typically within a range from several mPa·s to several tens of thousand mPa·s (for example, from 1 to 20,000 mPa·s, and preferably from 2 to 10,000 mPa·s).

Examples of the hydrolyzable group represented by W include alkoxy groups such as a methoxy group, ethoxy group, propoxy group, butoxy group, methoxyethoxy group or isopropenoxy group; acyloxy groups such as an acetoxy group; amino groups such as an ethylamino group; oxime groups such as an ethylmethylbutanoxime group; and a halogen atom such as a chlorine atom or bromine atom.

Specific examples of the organopolysiloxane containing hydrolyzable groups bonded to silicon atoms that may be used as the component (B1) include the compounds shown below.

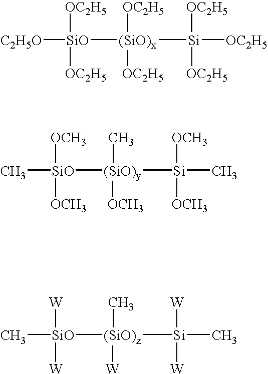

In these formulas, W represents a hydrolyzable group such as CH₃COO—, CH₃(C₂H₅)C═NO—, (C₂H₅)₂N—, CH₃CO(C₂H₅)N— and CH₂═C(CH₃)—O—, and x, y and z each represent an integer from 0 to 500.

### —Catalyst (C1)

The reaction between the component (A1) and the component (B1) may be conducted without adding a catalyst (C₁), but in those cases where there are strict limitations placed on the reaction conditions, such as when the heating temperature is limited, a catalyst (C₁) is used. Examples of preferred catalysts for use as the component (C1) include acids such as hydrochloric acid, phosphoric acid, methanesulfonic acid, para-toluenesulfonic acid, maleic acid and trifluoroacetic acid; alkalis such as sodium hydroxide, potassium hydroxide, sodium ethoxide and tetraethylammonium hydroxide; salts such as ammonium chloride, ammonium acetate, ammonium fluoride and sodium carbonate; organic acid salts of metals such as magnesium, aluminum, zinc, iron, zirconium, cerium and titanium; and organometallic compounds such as alkoxides and chelate compounds, including dioctyltin dioctoate, zinc dioctoate, titanium tetraisopropoxide, aluminum tributoxide and zirconium tetraacetylacetonate.

The above catalyst is used in an effective catalytic quantity. The quantity of the catalyst may be increased or decreased in accordance with the desired curing rate or the like, although a typical effective catalytic quantity is within a range from 0.1 to 5% by mass relative to the combined mass of the component (A1) and the component (B1).

### (Addition Reaction Curable Silicone Compositions)

A composition comprising the components described below may be used as an addition reaction curable silicone composition. The components (A2), (B2) and (C2) may each be either a single compound, or a combination of two or more different compounds.

(A2): an organopolysiloxane having at least two alkenyl groups within each molecule,

(B2): an organohydrogenpolysiloxane having at least two, and preferably three or more, SiH groups within each molecule, and

(C2): a platinum group metal-based catalyst.

### —Organopolysiloxane (A2)

Examples of the organopolysiloxane of the component (A2), having at least two alkenyl groups within each molecule, include the compounds represented by the general formula (2) shown below.

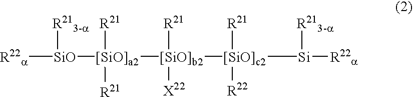

[wherein, R²¹ has the same meaning as R¹¹ in the above general formula (1), at least 80% of the R²¹ groups are preferably methyl groups, R²² represents an alkenyl group, 25×22 represents a group represented by the formula shown below:

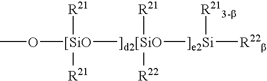

(wherein, R²¹ and R²² are as defined above), and
a2, b2, c2, d2 and e2 are positive numbers such that the viscosity at 25° C. of the organopolysiloxane (A2) is at least 0.05 Pa·s, the viscosity at 25° C. of a 30% toluene solution of the organopolysiloxane (A2) is within a range from 0.002 to 30 Pa·s, and preferably from 0.005 to 20 Pa·s, b2, c2, d2 and e2 may be zero, a2, b2, c2, d2 and e2 preferably satisfy 28≦a2+b2×(d2+e2+2)+c2≦10,000, and α and β each represent 0, 1, 2 or 3, provided that b2×(e2+β)+c2+2×α≧2].

In the above formulas, examples of the R²² groups include a vinyl group, allyl group, propenyl group, butenyl group, pentenyl group, hexenyl group, cyclohexenyl group or heptenyl group, and of these, a vinyl group is preferred.

The alkenyl groups of the organopolysiloxane (A2) react with the SiH groups within the cross-linking agent (B2) described below, thereby curing the addition reaction curable silicone composition. The organopolysiloxane (A2) must contain at least two alkenyl groups within each molecule. If this number of alkenyl groups is less than two, then the curability of the silicone composition deteriorates, and the desired silicone release layer may not be able to be formed.

The alkenyl group content per 100 g of the organopolysiloxane (A2) is preferably within a range from 0.001 to 0.1 mols. If the alkenyl group content is less than the lower limit of this range, then the curability of the silicone composition deteriorates, and the desired silicone release layer may not be able to be formed, whereas if the alkenyl group content exceeds the upper limit, the non-adhesiveness of the silicone release layer tends to deteriorate. In the formula (2), the number of alkenyl groups within a single molecule, represented by b2×(e2+p)+c2+2×α is preferably within a range from 2 to 150.

### —Organohydrogenpolysiloxane (B2)

The component (B2), which functions as a cross-linking agent in the addition reaction with the component (A2), is an organohydrogenpolysiloxane having at least two, and preferably three or more, SiH groups within each molecule, and may utilize the same compounds as the organohydrogenpolysiloxanes described above for the component (B1). The component (B2) is preferably used in a quantity such that the number of mols of SiH groups within the component (B2) is 1 to 5 times the number of mols of alkenyl groups within the component (A2). Typically, the quantity of the component (B2) is within a range from 0.1 to 30 parts by mass, and preferably from 0.1 to 20 parts by mass, per 100 parts by mass of the component (A2). If the number of mols of SiH groups is less than the lower limit of this range, then the quantity of cross-linked bonding generated by the addition reaction between the alkenyl groups and SiH groups is insufficient, and the non-adhesiveness of a silicone release layer formed from a cured product of the silicone composition tends to deteriorate. On the other hand, no improvement in effects is observed even if the number of mols of SiH groups exceeds the above upper limit, and not only does the cost performance ratio tend to deteriorate, but the composition actually tends to become prone to change over time.

### —Platinum Group Metal-based Catalyst (C2)

Examples of the platinum group metal-based catalyst (C2) used in the reaction between the components (A2) and (B2) include platinum black, platinum-vinylsiloxane complexes, chloroplatinic acid, chloroplatinic acid-olefin complexes, chloroplatinic acid-alcohol coordination compounds, rhodium, and rhodium-olefin complexes. The catalyst (C2) is used in an effective catalytic quantity. Typically, the quantity of platinum or rhodium is within a range from 0 to 5% by mass, and preferably from 5 to 1,000 ppm (mass ratio), relative to the combined mass of the component (A2) and the component (B2).

### (Ultraviolet Curable Silicone Compositions)

Examples of ultraviolet curable silicone compositions include silicone compositions that cure via a cationic polymerization, and silicone compositions that cure via a radical polymerization.

A composition comprising the components described below may be used as a silicone composition that cures via a cationic polymerization. The components (A3) and (C3) may each be either a single compound, or a combination of two or more different compounds.

(A3): an epoxy group-containing organopolysiloxane, and

(C3): a photocationic initiator.

Furthermore, a composition comprising the components described below may be used as a silicone composition that cures via a radical polymerization. The components (A4) and (C4) may each be either a single compound, or a combination of two or more different compounds.

(A4): a (meth)acrylic group-containing organopolysiloxane, and

(C4): a photoradical initiator.

In the present description, the term “(meth)acrylic” is used as a term that includes both “acrylic” and “methacrylic”.

### —Organopolysiloxane (A3)

Examples of the epoxy group-containing organopolysiloxane of the component (A3) include compounds represented by the general formula (3) shown below.

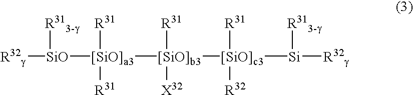

[wherein, R³¹ has the same meaning as R¹¹ in the above general formula (1), R³² represents an epoxy group-containing group, X³² represents a group represented by the formula shown below:

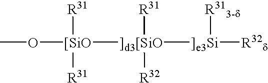

(wherein, R³¹ and R³² are as defined above), and
a3, b3, c3, d3 and e3 are positive numbers such that the viscosity at 25° C. of the organopolysiloxane (A3) is at least 0.05 Pa·s, the viscosity at 25° C. of a 30% toluene solution of the organopolysiloxane (A3) is within a range from 0.002 to 30 Pa·s, and preferably from 0.005 to 20 Pa·s, b3, c3, d3 and e3 may be zero, a3, b3, c3, d3 and e3 preferably satisfy 28≦a3+b3×(d3+e3+2)+c3≦10,000, and y and 6 each represent 0, 1, 2 or 3, provided that b3×(e3+6)+c3+2×y≧2].

In the above formulas, examples of the R³² groups include an epoxy group, glycidyl group, β-glycidoxyethyl group, α-glycidoxypropyl group, β-glycidoxypropyl group, γ-glycidoxypropyl group, α-glycidoxybutyl group, β-glycidoxybutyl group, γ-glycidoxybutyl group, 6-glycidoxybutyl group, 3,4-epoxycyclohexyl group, (3,4-epoxycyclohexyl)methyl group, β-(3,4-epoxycyclohexyl)ethyl group, γ-(3,4-epoxycyclohexyl)propyl group, and 6-(3,4-epoxycyclohexyl)butyl group.

The epoxy group content per 100 g of the organopolysiloxane (A3) is preferably within a range from 0.001 to 0.5 mols. In the formula (3), the number of epoxy groups within a single molecule, represented by b3×(e3+8)+c3+2×y is preferably within a range from 2 to 1,000.

### —Photocationic Initiator (C3)

Examples of the photocationic initiator include onium salt-based photoinitiators, and specific examples include diaryliodonium salts, triarylsulfonium salts, triarylselenonium salts, tetraaryl phosphonium salts and aryldiazonium salts represented by the formulas Ar₂I⁺X⁻, Ar₃S⁺X⁻, Ar₃Se⁺X⁻, Ar₄P⁺X⁻ and ArN⁺≡NX⁻ respectively (wherein, Ar represents an aryl group, and X⁻ represents an anion such as SbF₆⁻, AsF₆⁻, PF₆⁻, BF₄⁻, HSO₄⁻ and ClO₄⁻).

The quantity added of the photocationic initiator is typically within a range from 0.1 to 20 parts by mass per 100 parts by mass of the combination of the components (A3) and (B3). If the quantity of the photocationic initiator is less than 0.1 parts by mass, then the curing of the resulting composition may be unsatisfactory, whereas if the quantity exceeds 20 parts by mass, the non-adhesiveness of the silicone release layer may deteriorate.

### —Organopolysiloxane (A4)

Examples of the (meth)acrylic group-containing organopolysiloxane of the component (A4) include the compounds represented by the general formula (4) shown below.

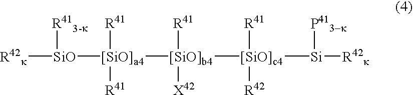

[wherein, R⁴¹ has the same meaning as R¹¹ in the above general formula (1), R⁴² represents a (meth)acrylic group, X⁴² represents a group represented by the formula shown below:

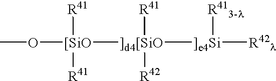

(wherein, R⁴¹ and R⁴² are as defined above), and
a4, b4, c4, d4 and e4 are positive numbers such that the viscosity at 25° C. of the organopolysiloxane (A4) is at least 0.05 Pa·s, the viscosity at 25° C. of a 30% toluene solution of the organopolysiloxane (A4) is within a range from 0.002 to 30 Pa·s, and preferably from 0.005 to 20 Pa·s, b4, c4, d4 and e4 may be zero, a4, b4, c4, d4 and e4 preferably satisfy 28≦a4+b4×(d4+e4+2)+c4≦10,000, and K and X each represent 0, 1, 2 or 3, provided that b4×(e4+λ)+c4+2×κ≧2].

In the above formulas, examples of the R⁴² groups include a 3-acryloyloxypropyl group and 3-methacryloyloxypropyl group.

The (meth)acrylic group content per 100 g of the organopolysiloxane (A4) is preferably within a range from 0.001 to 5 mols. In the formula (4), the number of (meth)acrylic groups within a single molecule, represented by b4×(e4+λ)+c4+2×κ is preferably within a range from 2 to 1,000.

—Photoradical initiator (C4)

Examples of photoradical initiators that may be used include conventional materials such as benzoin and derivatives thereof, benzoin ethers such as benzoin acrylic ether, benzil and derivatives thereof, aromatic diazonium salts, anthraquinone and derivatives thereof, acetophenone and derivatives thereof, sulfur compounds such as diphenyl disulfide, and benzophenone and derivatives thereof.

The quantity added of the photoradical initiator is typically within a range from 0.1 to 5 parts by mass per 100 parts by mass of the combination of the components (A4) and (B4), although the quantity may fall outside this range depending on the nature and properties of the initiator selected.

### (Form of the Curable Silicone Composition)

These condensation reaction curable, addition reaction curable, and ultraviolet curable silicone compositions may be used as is, namely, in a solventless form that contains no organic solvents, or may be diluted with an organic solvent and used in the form of a solution. Examples of organic solvents that may be used include aromatic hydrocarbons such as toluene and xylene; aliphatic hydrocarbons such as hexane, heptane, octane and cyclohexane; ethers such as diethyl ether and dipropyl ether; ketones such as acetone, methyl ethyl ketone, methyl isobutyl ketone and cyclohexanone; esters such as ethyl acetate and propyl acetate; and alcohols such as ethyl alcohol and propyl alcohol. These organic solvents may be used either alone, or in combinations of two or more different solvents.

The blend quantity of the organic solvent is typically within a range from 10 to 100,000 parts by mass, and preferably from 100 to 10,000 parts by mass, per 100 parts by mass of the curable silicone composition.

Furthermore, an emulsion-based silicone composition may be obtained by dispersing a condensation reaction curable or addition reaction curable silicone composition in water. In those cases where emulsification is difficult, or the formed emulsion is unstable, a surfactant may be used as required. Although cationic, anionic or nonionic surfactants may be used, in the case of an addition reaction curable composition, a nonionic surfactant such as a polyoxyalkylene alkyl ether-based surfactant is preferred. Either a single surfactant may be used alone, or a combination of two or more different surfactants may be used. The blend quantity of the surfactant is preferably not more than 20% by mass relative to either the combined mass of the components (A1) and (B1), or the combined mass of the components (A2) and (B2). If the blend quantity exceeds this limit, then the non-adhesiveness of a silicone release layer formed from a cured product of the silicone composition tends to deteriorate. The emulsification may be conducted using conventional methods, and methods that employ a homogenizer are typical. Furthermore, a method in which an emulsion of the component (A1) or (A2) is prepared by a conventional emulsification polymerization method, using octamethylcyclotetrasiloxane or the like as a raw material, and other components are then added to the prepared emulsion, may also be used.

The quantity of water within an aqueous emulsion-based or aqueous solution silicone composition, is typically within a range from 10 to 10,000 parts by mass, and preferably from 20 to 5,000 parts by mass, per 100 parts by mass of the curable silicone composition.

In recent years, environmental impact concerns and a desire to improve the health and safety of the workplace environment have resulted in a strong tendency to avoid the use of solvent-based compositions. Using the method of the present invention enables favorable adhesion to be achieved between the plastic film substrate and the silicone release layer even when a solventless, aqueous emulsion-based or aqueous solution-based silicone composition is used. Particularly in the case of emulsion-based compositions, poor wetting of the plastic film substrate by the composition has meant that, conventionally, the actual coating process itself has been problematic, but by using the method of the present invention, the wetting properties can be improved, resulting in favorable coating properties.

### (Other Components)

In addition to the components described above, other conventional components may also be added to the curable silicone composition, provided their inclusion does not impair the objects of the present invention. Examples of these other components include catalytic activity inhibitors such as various organonitrogen compounds, organophosphorus compounds, acetylene derivatives, oxime compounds and organohalides, which may be added for the purpose of suppressing the catalytic activity of the platinum group metal-based catalyst; silicone resins, silica or organopolysiloxanes that contain no SiH groups or silicon atom-bonded alkenyl groups, which may be added for the purpose of controlling the non-adhesiveness of the produced silicone release layer; leveling agents; thickeners, including water-soluble polymers such as cellulose derivatives like methyl cellulose and starch derivatives; and other conventional improvers such as styrene-maleic anhydride copolymers, which may be added to improve the film-forming properties of the composition.

### (Specific Examples)

Specific examples of the curable silicone composition used in the present invention include condensation reaction solvent-based silicones such as KS705F; addition reaction solvent-based silicones such as KS776A, KS838, KS839, KS778, KS3502, KS774 and KS847; addition reaction solventless silicones such as KNS320A and KNS305; addition reaction emulsion-based silicones such as KM768 and KM3951; and ultraviolet curable silicones such as KNS5300, KS5508 and X-62-7622 (all of the above represent the names of products manufactured by Shin-Etsu Chemical Co., Ltd.).

### [Silicone Release Layer]

The silicone release layer is composed of a cured product of the curable silicone composition, and is provided on top of the above surface modification layer. The silicone release layer can be formed on the surface modification layer by applying the curable silicone composition to the surface modification layer, and then curing the composition. Specifically, a treatment bath is prepared from a curable silicone composition containing a specific quantity of a predetermined curing agent, the curable silicone composition is applied uniformly, with the desired thickness, to the surface modification layer using a coating device such as a roll coater, and the composition is then cured by passage through a dryer or a UV irradiation device or the like. For example, in the case of heat curing using a dryer, typical conditions involve heating at a temperature of at least 100° C. for a period of at least 10 seconds. In the case of UV curing, irradiation is conducted using a high-pressure mercury lamp, mid-pressure mercury lamp, low-pressure mercury lamp, xenon lamp, metal halide lamp or mercury arc lamp or the like, and a typical irradiation dose is within a range from 10 to 100 mJ/cm². For example, if a lamp with an output of 80 W is used, then a line speed of not more than 40 m/minute is appropriate.

Although there are no particular restrictions on the coating quantity of the curable silicone composition, a quantity within a range from 0.1 to 1.0 g/m² provides a favorable balance between release performance, productivity and cost. Examples of other coating devices that may be used, besides the roll coater mentioned above, include a direct gravure coater, bar coater or air knife coater, and in those cases where application of a very thin film of reduced thickness is required, a high-precision offset coater or multistage roll coater may be used.

### [Release Film]

A release film of the present invention can be produced by:

forming a surface modification layer on a single surface or both surfaces of a plastic film substrate by radiating a flame of a fuel gas comprising an organosilicon compound onto the single surface or both surfaces, and

forming a silicone release layer composed of a cured product of a curable silicone composition on top of the surface modification layer by applying the curable silicone composition to the surface modification layer and then curing the composition.

The conditions for the flame radiation and the conditions used during application and curing of the curable silicone composition are as described above.

The surface free energy of a release film of the present invention is preferably within a range from 30 to 80 mJ/cm², and is even more preferably from 30 to 70 mJ/cm². Provided the surface free energy is within this range, the wetting properties, coating properties and adhesiveness of the release film can be effectively improved.

### EXAMPLES

A more detailed description of the present invention is presented below using a series of examples and comparative examples, although the scope of the present invention is in no way limited by these examples.

### Example 1

A PET film of thickness 40 μm was irradiated with the flame of a fuel gas composed of propane gas and tetramethylsilane gas (molar ratio 1:0.000001) from a burner positioned at a height of 15 mm above the film. The PET film was passed under the burner on a conveyor, with the speed of the conveyor set to 20 mm/minute. The flame-radiated PET film had a surface tension of 71.3 mN/m.

The surface tension of the flame-radiated film was determined in the manner described below. Namely, a contact angle meter was first used to measure the contact angles for water and methylene iodide on the film surface (θ1 and θ2 respectively). Subsequently, the measured contact angles, together with the surface tension values for water and methylene iodide, were inserted into the equation shown below, and the two resulting simultaneous equations were solved, yielding values for γd and γp. The surface tension γ was calculated as the sum of γd and γp.

{(1+cos θ)·γ1}/2=(γd·γ1d)^{1/2}+(γp·γ1p)^{1/2}

(wherein, γ1 represents the surface tension of a liquid, and γ1d and γ1p represent the dispersive component and the polar component respectively of the surface tension, wherein γ1=γ1d+γ1p)

The calculations were conducted with the dispersive component and polar component of the surface tension of water set as 21.8 mN/m and 51.0 mN/m respectively, and the dispersive component and polar component of the surface tension of methylene chloride set as 48.5 mN/m and 2.3 mN/m respectively.

Subsequently, a solvent-based condensation reaction curable silicone composition containing the components listed below was applied to the surface of the flame-radiated PET film in sufficient quantity to yield a coating quantity, reported as a solid fraction quantity, of 0.5 g/m². The composition was then dried for 30 seconds at 120° C. in a hot air dryer, thereby curing the silicone composition, forming a silicone release layer, and completing production of the release film.

The silicone composition was a solution, containing:

(A1) 100 parts by mass of a straight-chain dimethylpolysiloxane containing two silanol groups within each molecule (silanol group content=0.0005 mol/100 g) and having a viscosity at 25° C. in a 30% toluene solution of 10 Pa·s,

(B1) 1 part by mass of a straight-chain methylhydrogenpolysiloxane having a viscosity at 25° C. of 25 mPa·s and a SiH content of 1.5 mols/100 g (containing 30 times as many mols of SiH groups as the number of mols of silanol groups within the component (A1)), and

(C1) 5 parts by mass of dioctyltin dioctoate as a catalyst dissolved uniformly in 2,000 parts by mass of toluene.

### Example 2

Using the same method as the example 1, a solventless addition reaction curable silicone composition containing the components listed below was applied to the surface of a flame-radiated PET film in sufficient quantity to yield a coating quantity, reported as a solid fraction quantity, of 0.5 g/m². The composition was then dried for 30 seconds at 120° C. in a hot air dryer, thereby curing the silicone composition, forming a silicone release layer, and completing production of the release film.

The silicone composition contained:

(A2) 100 parts by mass of a straight-chain diorganopolysiloxane with a viscosity at 25° C. of 0.4 Pa·s, in which 99 mol % of the organic groups bonded to silicon atoms were methyl groups and the remaining 1 mol % were vinyl groups (vinyl group content 0.03 mol/100 g),

(B2) 4 parts by mass of a straight-chain methylhydrogenpolysiloxane having a viscosity at 25° C. of 25 mPa·s and a SiH content of 1.5 mols/100 g (containing twice as many mols of SiH groups as the number of mols of alkenyl groups within the component (A2)), and

(C2) a platinum-vinylsiloxane complex as a catalyst, in sufficient quantity that the ratio of platinum atoms relative to the combined mass of the component (A2) and the component (B2) was 100 ppm.

### Example 3

Using the same method as the example 1, an emulsion-based addition reaction silicone composition containing the components listed below was applied to the surface of a flame-radiated PET film in sufficient quantity to yield a coating quantity, reported as a solid fraction quantity, of 0.5 g/m². The composition was then dried for 30 seconds at 120° C. in a hot air dryer, thereby curing the silicone composition, forming a silicone release layer, and completing production of the release film.

The emulsion-based composition contained:

(A2) 100 parts by mass of a straight-chain diorganopolysiloxane with a viscosity at 25° C. of 0.4 Pa·s, in which 99 mol % of the organic groups bonded to silicon atoms were methyl groups and the remaining 1 mol % were vinyl groups (vinyl group content=0.03 mol/100 g),

(B2) 4 parts by mass of a straight-chain methylhydrogenpolysiloxane having a viscosity at 25° C. of 25 mPa·s and a SiH content of 1.5 mols/100 g (containing twice as many mols of SiH groups as the number of mols of alkenyl groups within the component (A2)), and

(C2) a platinum-vinylsiloxane complex as a catalyst, in sufficient quantity that the ratio of platinum atoms relative to the combined mass of the component (A2) and the component (B2) was 100 ppm

emulsified within a mixture containing 936 parts by mass of water and 1 part by mass of a polyoxyalkylene alkyl ether-based surfactant.

### Example 4

Using the same method as the example 1, a solventless photocationic curable silicone composition containing the components listed below was applied to the surface of a flame-radiated PET film in sufficient quantity to yield a coating quantity, reported as a solid fraction quantity, of 0.5 g/m². The composition was then irradiated with ultraviolet light at a dosage of 70 mJ/cm² using two 80 W/cm high-pressure mercury lamps, thereby curing the silicone composition, forming a silicone release layer, and completing production of the release film.

The silicone composition contained:

(A3) 100 parts by mass of an epoxy group-containing straight-chain diorganopolysiloxane having a viscosity at 25° C. of 280 mPa·s, in which the organic groups bonded to the silicon atoms consisted of epoxy group-containing groups represented by the formula shown below:

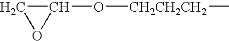

and methyl groups, and the epoxy equivalent weight was 620 g/mol (namely, an epoxy group content of 0.16 mols/100 g), and

(B3) 1 part by mass of an iodonium salt photoinitiator CAT-7605 (a product name, manufactured by Shin-Etsu Chemical Co., Ltd.)

### Comparative Example 1

With the exception of using the PET film of thickness 40 μm as is, without conducted the flame radiation treatment, a silicone release layer was formed in the same manner as the example 1.

### Comparative Example 2

With the exception of using the PET film of thickness 40 μm as is, without conducted the flame radiation treatment, a silicone release layer was formed in the same manner as the example 2.

### Comparative Example 3

With the exception of using the PET film of thickness 40 μm as is, without conducted the flame radiation treatment, a silicone release layer was formed in the same manner as the example 3.

### Comparative Example 4

With the exception of using the PET film of thickness 40 μm as is, without conducted the flame radiation treatment, a silicone release layer was formed in the same manner as the example 4.

### —Evaluation Methods

### 1) Coating Properties

The surface state of the cured silicone release layer was inspected and evaluated using the following criteria.

O: a smooth and uniform surface

Δ: localized unevenness or cissing noticeable

×: unevenness or cissing noticeable across entire surface

### 2) Curability

The surface of the silicone release layer was rubbed with a finger immediately following curing, and the degree of clouding of the film surface was inspected visually and evaluated using the following criteria.

O: absolutely no clouding

Δ: slight clouding

×: heavy clouding or film detachment

### 3) Adhesion

Following curing of the silicone composition, the release film was left to stand for one week at 25° C. and a humidity of 60%, and the surface of the silicone release layer was then rubbed with a finger, and the degree of detachment at the film surface was evaluated using the following criteria.

O: absolutely no detachment

Δ: slight detachment

×: detachment occurred readily

### 4) Releasability

Following curing of the silicone composition, the release film was left to stand for one day at 25° C., and an acrylic-based solvent-type pressure-sensitive adhesive (product name: Oribain BPS-5127, manufactured by Toyo Ink Mfg. Co., Ltd.) was then applied to the surface of the silicone release layer and heated at 100° C. for 3 minutes. A 40 μm PET film was then bonded to this treated surface, the laminated structure was compressed by rolling a 2 kg roller back and forth once across the structure, and aging was then conducted for 20 hours at 25° C. The resulting sample was cut into strips of width 5 cm, the latterly bonded PET film was peeled away from the sample at an angle of 180° and a peel speed of 0.3 m/minute using a tensile tester, and the force (N) required to peel the PET film was measured. The measurement was conducted using an Autograph DSC-500 (manufactured by Shimadzu Corporation).

### —Evaluation Results

The results of the above evaluations are shown below in Table 1.

TABLE 1

| | Coating | | | |
|---|---|---|---|---|
| Evaluation item | properties | Curability | Adhesion | Releasability (N) |
| Example 1 | ∘ | ∘ | ∘ | 0.1 |
| Example 2 | ∘ | ∘ | ∘ | 0.3 |
| Example 3 | ∘ | ∘ | ∘ | 0.5 |
| Example 4 | ∘ | ∘ | ∘ | 1.0 |
| Comparative | ∘ | ∘ | Δ | 0.2 |
| example 1 | | | | |
| Comparative | Δ | Δ | x | x |
| example 2 | | | | |
| Comparative | x | x | x | x |
| example 3 | | | | |
| Comparative | ∘ | ∘ | Δ | 2.0 |
| example 4 | | | | |

Note:
a “x” in the “Releasability” column indicates unsatisfactory peeling.

What is claimed is:

1. A release film, comprising:
a plastic film substrate,
a surface modification layer formed on a single surface or both surfaces of the plastic film substrate by radiating a flame of a fuel gas comprising an organosilicon compound onto the single surface or both surfaces, and
a silicone release layer composed of a cured product of a curable silicone composition, wherein
the silicone release layer is provided on top of the surface modification layer.

2. The release film according to claim 1, wherein the organosilicon compound is at least one organosilane selected from the group consisting of alkylsilanes and alkoxysilanes.

3. The release film according to claim 2, wherein the organosilane is represented by a general formula shown below: 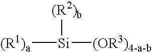
(wherein, R¹ represents an alkyl group of 1 to 8 carbon atoms that may include an ether linkage or ester linkage, wherein one hydrogen atom within the alkyl group is substituted with a moiety selected from the group consisting of halogen atoms, a vinyl group, epoxy group, acryloyloxy group, methacryloyloxy group, styryl group, amino group, N-substituted amino groups, mercapto group, perfluoroalkyl groups, ureido group, chloroalkyl groups, isocyanate group, acetoxy group and phenyl group,
R² and R³ each represent an alkyl group of 1 to 10 carbon atoms,
a represents an integer of 0 to 3, and b represents an integer of 0 to 4, provided that a+b is an integer from 0 to 4,
when a represents either 2 or 3, the R¹ groups may be identical or different,
when b represents an integer from 2 to 4, the R² groups may be identical or different, and
when 4-a-b represents an integer from 2 to 4, the R³ groups may be identical or different).

4. The release film according to claim 1, wherein the surface modification layer is a silica microparticle layer composed of nanosize silica microparticles, and a surface free energy of the release film is within a range from 30 to 80 mJ/cm².

5. The release film according to claim 1, wherein the curable silicone composition is a solventless composition containing no organic solvents, and is cured by a condensation reaction, an addition reaction, a photocationic polymerization reaction, or a photoradical polymerization reaction.

6. The release film according to claim 1, wherein the curable silicone composition is an aqueous emulsion or an aqueous solution, and is cured by a condensation reaction, an addition reaction, a photocationic polymerization reaction, or a photoradical polymerization reaction.

7. A method of producing the release film defined in claim 1, the method comprising:
forming a surface modification layer on a single surface or both surfaces of the plastic film substrate by radiating a flame of a fuel gas comprising an organosilicon compound onto the single surface or both surfaces, and
forming a silicone release layer composed of a cured product of a curable silicone composition on top of the surface modification layer by applying the curable silicone composition to the surface modification layer and then curing the composition.
